(19) United States
(12) Patent Application Publication
(10) Pub. No.: US 2016/0171544 A1
(43) Pub. Date: Jun. 16, 2016

(54) METHODS AND SYSTEMS FOR PROVIDING INFORMATION REGARDING COUPONS/PROMOTIONS AT KIOSKS FOR RECYCLING MOBILE PHONES AND OTHER ELECTRONIC DEVICES

(71) Applicant: ecoATM, Inc., San Diego, CA (US)

(72) Inventors: Larry Heminger, San Diego, CA (US); Mark Vincent Bowles, San Diego, CA (US); Eric Rosser, San Diego, CA (US)

(21) Appl. No.: 14/964,963

(22) Filed: Dec. 10, 2015

Related U.S. Application Data
(60) Provisional application No. 62/090,855, filed on Dec. 11, 2014.

(51) Int. Cl. G06Q 30/02; G01S 19/13

(52) U.S. Cl. CPC G06Q 30/0257; G06Q 30/0241; G06Q 30/0272; G01S 19/13

(57) ABSTRACT

The present disclosure describes various embodiments of methods and systems for providing a kiosk with coupon/promotion information that is selected for the physical location of the kiosk or the owner of the location where the kiosk is located. A server computer is connected to the kiosks through a communication network that may include a wired or wireless link. A database at the server stores information about coupons/promotions that is transmitted to individual kiosks and stored in memory. The coupon/promotion information is sent to one or more kiosks when an operator of the server chooses to update the information. In another embodiment, a kiosk sends identifying information that can be analyzed to determine if any new coupon/promotion information is available for the kiosk.

### CROSS-REFERENCE TO RELATED APPLICATIONS

This application claims priority to U.S. Patent Provisional Application No. 62/090,855, titled “METHODS AND SYSTEMS FOR PROVIDING INFORMATION REGARDING COUPONS/PROMOTIONS AT KIOSKS FOR RECYCLING MOBILE PHONES AND OTHER ELECTRONIC DEVICES” filed Dec. 11, 2014, and is incorporated herein by reference in its entirety.

### TECHNICAL FIELD

The present disclosure is directed generally to methods and systems for recycling mobile phones and other consumer electronic devices and, more particularly, to methods and systems for providing information about coupons, promotions and/or other offers for such devices to remotely located kiosks.

### BACKGROUND

Consumer electronic devices, such as mobile phones, laptop computers, notebooks, tablets, MP3 players, etc., are ubiquitous. Currently there are over 6 billion mobile devices in use in the world; and this number is growing rapidly as more than 1.8 billion mobile phones were sold in 2013 alone. By 2017 it is expected that there will be more mobile devices in use than people on the planet. In addition to mobile phones, over 300 million desk-based and notebook computers shipped in 2013, and for the first time the number of tablet computers shipped exceeded laptops. Part of the reason for the rapid growth in the number of mobile phones and other electronic devices is the rapid pace at which these devices evolve, and the increased usage of such devices in developing countries.

As a result of the rapid pace of development, a relatively high percentage of electronic devices are replaced every year as consumers continually upgrade their mobile phones and other electronic devices to obtain the latest features or a better operating plan. According to the U.S. Environmental Protection Agency, consumers in the United States alone dispose of over 370 million mobile phones, PDAs, tablets, and other electronic devices every year. Millions of other outdated or broken mobile phones and other electronic devices are simply tossed into junk drawers or otherwise kept until a suitable disposal solution arises.

Although many electronic device retailers and cell carrier stores now offer mobile phone trade-in or buyback programs, many old mobile phones still end up in landfills or are improperly disassembled and disposed of in developing countries. Mobile phones and similar electronic devices, however, typically contain substances that can be harmful to the environment, such as arsenic, lithium, cadmium, copper, lead, mercury and zinc. If not properly disposed of, these toxic substances can seep into groundwater from decomposing landfills and contaminate the soil with potentiality harmful consequences for humans and the environment.

an alternative to retailer trade-in or buyback programs, consumers can now recycle and/or sell their used mobile phones using self-service kiosks located in malls, retail stores or other publically accessible areas. Such kiosks are operated by ecoATM, Inc., the assignee of the present application, and are disclosed in, for example, U.S. Pat. Nos. 8,463,646, 8,423,404, 8,239,262, 8,200,533, 8,195,511, and 7,881,965, which are commonly owned by ecoATM, Inc. and are incorporated herein by reference in their entireties.

### BRIEF DESCRIPTION OF THE DRAWINGS

FIG. 1 is an isometric view of a machine configured in accordance with an embodiment of the present technology for recycling mobile phones and/or other electronic devices.

FIGS. 2A-2D are a series of isometric views of the machine of FIG. 1 with a number of exterior panels removed to illustrate operation of the machine in accordance with an embodiment of the present technology.

FIG. 3 is a flow diagram of a routine for recycling mobile phones and/or other electronic devices in accordance with an embodiment of the present technology.

FIG. 4 illustrates a system for delivering information, such as information associated with coupons or other promotions to a plurality of automated kiosks in accordance with an embodiment of the present technology.

FIG. 5 shows an exemplary block diagram of a kiosk that stores and retrieves information for coupons/promotions from a remote server computer in accordance with an embodiment of the present technology.

FIG. 6 shows an exemplary user interface with which a user can select coupons/promotions that are to be transmitted to one or more selected kiosks.

### DETAILED DESCRIPTION

The following disclosure describes various embodiments of systems and methods for providing coupon/promotion information to a number of kiosks that purchase electronic equipment from users.

In order to entice users to exchange their used electronic equipment for cash or other consideration, coupons, promotions or other incentives are often offered to the users. Such coupons/promotions are often tied to the demographics of the users who are likely to encounter the kiosks. In addition, because the kiosks are often located in retail spaces that may have their own promotions in effect, it is useful to be able to tie the coupons/promotions offered by the kiosk to those offered by the particular retail space in which a kiosk is located. Due the wide geographic area in which kiosks are located and the large number of different retail spaces associated with the kiosks, the task of updating the kiosks with the current coupons/promotions can be significant.

In order to facilitate the placement of kiosks in favorable business locations, incentives are often provided to the landlord or owner of the business at the kiosk location. Such incentives can be in the form of coupons, promotions, bonus dollars, gift cards etc. (all referred to generically herein as “coupons/promotions”) that are redeemable at the business or location. Each type of coupon/promotion is designed to increase the likelihood that a kiosk user will spend at least a portion of a payment that is received for a redeemed electronic device at the business or location. With thousands of kiosks placed all over the country, there is a need for a cost effective and convenient mechanism to update the programming of the kiosks with updated or customized coupons/promotions.

Embodiments of the methods described herein can be performed by or with consumer-operated kiosks, networked processing devices, retailer-assisted machines, and/or the like. Some embodiments of the present technology, for example, are directed to consumer-operated kiosks that can perform automatic visual and/or electrical inspections of mobile phones and/or other consumer electronic devices that are submitted to the kiosks for sale or recycling. As described in greater detail below, the visual evaluation or inspection can be performed using one or more cameras or other imaging devices, and the electrical analysis can be performed using a suitable processing device connected to the subject electronic device via, e.g., a suitable electrical connector.

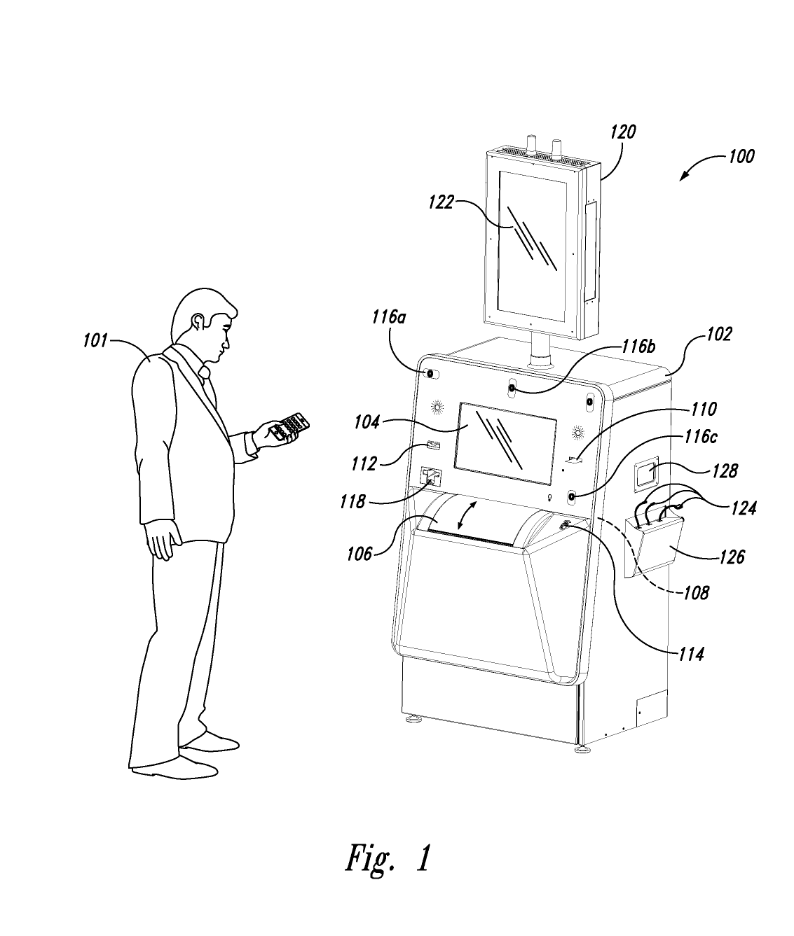

Certain details are set forth in the following description and in FIGS. 1-6 to provide a thorough understanding of various embodiments of the present technology. In other instances, well-known structures, materials, operations and/or systems often associated with smartphones and other handheld devices, consumer electronic devices, computer hardware, software, network and coupon/promotion systems, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth. The terminology used below should be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as the position of components and certain precise connections between such components when such details are unnecessary for a complete understanding of how to make and use the invention.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is an isometric view of a kiosk 100 for recycling and/or other processing of mobile phones and other consumer electronic devices in accordance with the present technology. The term “processing” is used herein for ease of reference to generally refer to all manner of services and operations that may be performed or facilitated by the kiosk 100 on, with, or otherwise in relation to an electronic device. Such services and operations can include, for example, selling, reselling, recycling, donating, exchanging, identifying, evaluating, pricing, auctioning, decommissioning, transferring data from or to, reconfiguring, refurbishing, etc., mobile phones and other electronic devices. Although many embodiments of the present technology are described herein in the context of mobile phones, aspects of the present technology are not limited to mobile phones and generally apply to other consumer electronic devices. Such devices include, as non-limiting examples, all manner of mobile phones, smart phones, handheld devices, PDAs, MP3 players, tablet, notebook and laptop computers, e-readers, cameras, etc. In some embodiments, it is contemplated that the kiosk 100 can facilitate selling and/or otherwise processing larger consumer electronic devices, such as desktop computers, TVs, game consoles, etc., as well smaller electronic devices such as Google Glass™, smart-watches, etc. The kiosk 100 and various features thereof can be at least generally similar in structure and function to the kiosks and corresponding features described in U.S. Pat. Nos. 8,463,646, 8,423,404, 8,239,262, 8,200,533, 8,195,511, and 7,881,965; and in U.S. patent application Ser. Nos. 12/573,089, 12/727,624, 13/113,497, 12/785,465, 13/017,560, 13/438,924, 13/753,539, 13/658,825, 13/733,984, 13/705,252, 13/487,299 13/492,835, 13/562,292, 13/658,828, 13/693,032, 13/792,030, 13/794,814, 13/794,816, 13/862,395 13/913,408; 62/059,129; 62/059,132; 14/498,763 and 14/500,739. All of the patents and patent applications listed in the preceding sentence are commonly owned by the applicant of the present application, and they along with any other patents or patent applications identified herein are incorporated herein by reference in their entireties.

In the illustrated embodiment, the kiosk 100 is a floor-standing self-service kiosk configured for use by a user 101 (e.g., a consumer, customer, etc.) to recycle, sell, and/or perform other operations with a mobile phone or other consumer electronic device. In other embodiments, the kiosk 100 can be configured for use on a countertop or a similar raised surface. Although the kiosk 100 is configured for use by consumers, in various embodiments the kiosk 100 and/or various portions thereof can also be used by other operators, such as a retail clerk or kiosk assistant to facilitate the selling or other processing of mobile phones and other electronic devices.

In the illustrated embodiment, the kiosk 100 includes a housing 102 that is approximately the size of a conventional vending machine. The housing 102 can be of conventional manufacture from, for example, sheet metal, plastic panels, etc. A plurality of user interface devices are provided on a front portion of the housing 102 for providing instructions and other information to users, and/or for receiving user inputs and other information from users. For example, the kiosk 100 can include a display screen 104 (e.g., a liquid crystal display (“LCD”) or light emitting diode (“LED”) display screen, a projected display (such as a heads-up display or a head-mounted device), and so on) for providing information, prompts, etc., to users. The display screen 104 can include a touch screen for receiving user input and responses to displayed prompts. In addition or alternatively, the kiosk 100 can include a separate keyboard or keypad for this purpose. The kiosk 100 can also include an ID reader or scanner 112 (e.g., a driver's license scanner), a fingerprint reader 114, and one or more cameras 116 (e.g., digital still and/or video cameras, identified individually as cameras 116a-c). The kiosk 100 can additionally include output devices such as a label printer having an outlet 110, and a cash dispenser having an outlet 118. Although not identified in FIG. 1, the kiosk 100 can further include a speaker and/or a headphone jack for audibly communicating information to users, one or more lights for visually communicating signals or other information to users, a handset or microphone for receiving verbal input from the user, a card reader (e.g., a credit/debit card reader, loyalty card reader, etc.), a receipt or voucher printer and dispenser, as well as other user input and output devices. The input devices can include a touchpad, pointing device such as a mouse, joystick, pen, game pad, motion sensor, scanner, eye direction monitoring system, etc. Additionally the kiosk 100 can also include a bar code reader, QR code reader, bag/package dispenser, a digital signature pad, etc. In the illustrated embodiment, the kiosk 100 additionally includes a header 120 having a display screen 122 for displaying marketing advertisements and/or other video or graphical information to attract users to the kiosk. In addition to the user interface devices described above, the front portion of the housing 102 also includes an access panel or door 106 located directly beneath the display screen 104. As described in greater detail below, the access door is configured to automatically retract so that the user 101 can place an electronic device (e.g., a mobile phone) in an inspection area 108 for automatic inspection by the kiosk 100.

A sidewall portion of the housing 102 can include a number of conveniences to help users recycle or otherwise process their mobile phones. For example, in the illustrated embodiment the kiosk 110 includes an accessory bin 128 that is configured to receive mobile device accessories that the user wishes to recycle or otherwise dispose of. Additionally, the kiosk 100 can provide a free charging station 126 with a plurality of electrical connectors 124 for charging a wide variety of mobile phones and other consumer electronic devices.

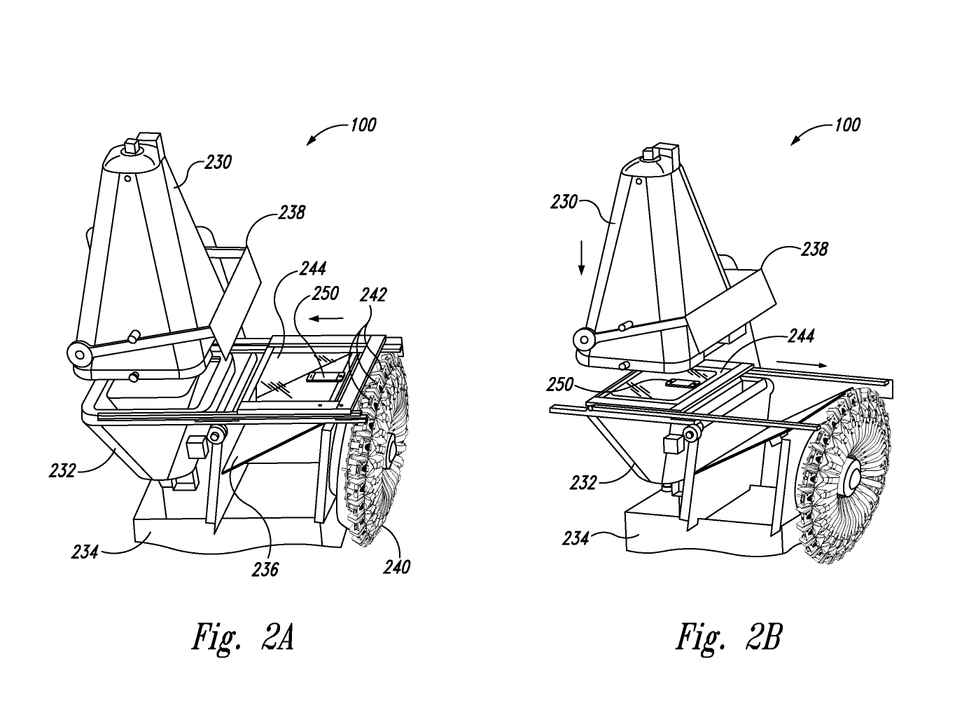

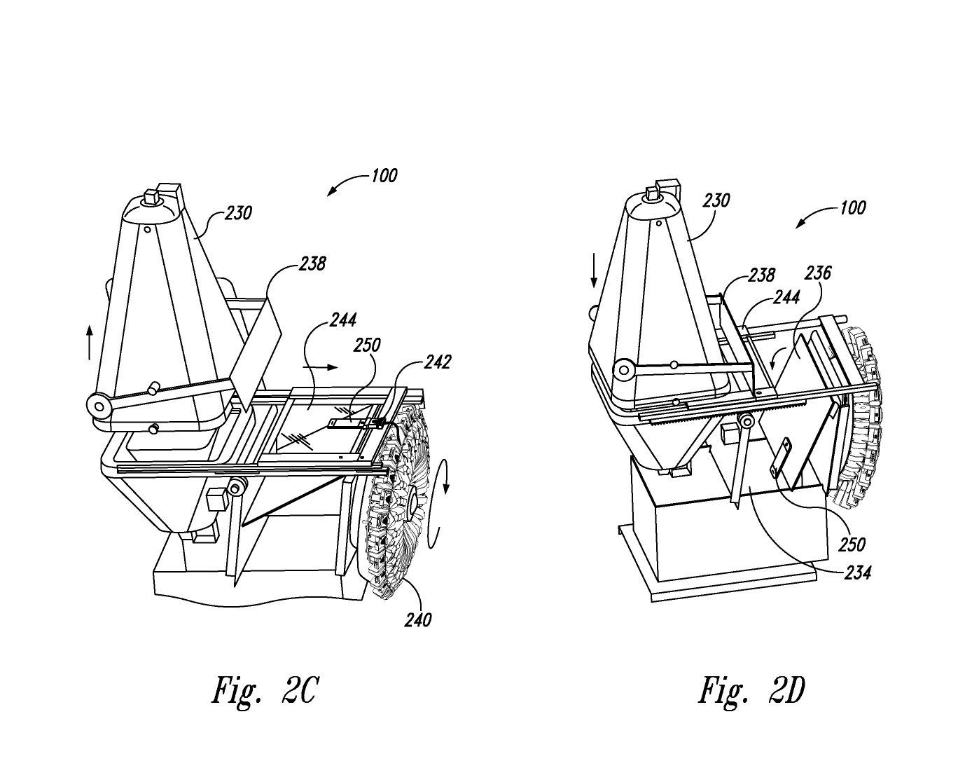

FIGS. 2A-2D are a series of isometric views of the kiosk 100 with the housing 102 removed to illustrate selected internal components configured in accordance with an embodiment of the present technology. Referring first to FIG. 2A, in the illustrated embodiment the kiosk 100 includes a connector carrier 240 and an inspection plate 244 operably disposed behind the access door 106 (FIG. 1). In the illustrated embodiment, the connector carrier 240 is a rotatable carrousel that is configured to rotate about a generally horizontal axis and carries a plurality of electrical connectors 242 (e.g., approximately 25 connectors) distributed around an outer periphery thereof. In other embodiments, other types of connector carrying devices (including both fixed and movable arrangements) can be used. In some embodiments, the connectors 242 can include a plurality of interchangeable USB connectors configured to provide power and/or exchange data with a variety of different mobile phones and/or other electronic devices. In operation, the connector carrier 240 is configured to automatically rotate about its axis to position an appropriate one of the connectors 242 adjacent to an electronic device, such as a mobile phone 250, that has been placed on the inspection plate 244 for recycling. The connector 242 can then be manually and/or automatically withdrawn from the connector carrier 240 and connected to a port on the mobile phone 250 for electrical analysis. Such analysis can include, e.g., an evaluation of the make, model, configuration, condition, etc., using one or more of the methods and/or systems described in detail in the commonly owned patents and patent applications identified herein and incorporated by reference in their entireties.

In the illustrated embodiment, the inspection plate 244 is configured to translate back and forth (on, e.g., parallel mounting tracks) to move an electronic device, such as the mobile phone 250, between a first position directly behind the access door 106 and a second position between an upper chamber 230 and an opposing lower chamber 232. Moreover, in this embodiment the inspection plate 244 is transparent, or at least partially transparent (e.g., formed of glass, Plexiglas, etc.) to enable the mobile phone 250 to be photographed and/or otherwise optically evaluated from all, or at least most viewing angles (e.g., top, bottom, sides, etc.) using, e.g., one or more cameras, mirrors, etc. mounted to or otherwise associated with the upper and lower chambers 230 and 232. When the mobile phone 250 is in the second position, the upper chamber 230 can translate downwardly to generally enclose the mobile phone 250 between the upper chamber 230 and the lower chamber 232. The upper chamber 230 is operably coupled to a gate 238 that moves up and down in unison with the upper chamber 230. As noted above, in the illustrated embodiment the upper chamber 230 and/or the lower chamber 232 can include one or more cameras, magnification tools, scanners (e.g., bar code scanners, infrared scanners, etc.) or other imaging components (not shown) and an arrangement of mirrors (also not shown) to view, photograph and/or otherwise visually evaluate the mobile phone 250 from multiple perspectives. In some embodiments, one or more of the cameras and/or other imaging components discussed above can be movable to facilitate device evaluation. The inspection area 108 can also include weight scales, heat detectors, UV readers/detectors, and the like, for further evaluation of electronic devices placed therein. The kiosk 100 can further include an angled binning plate 236 for directing electronic devices from the transparent plate 244 into a collection bin 234 positioned in a lower portion of the kiosk 100.

The kiosk 100 can be used in a number of different ways to efficiently facilitate the recycling, selling and/or other processing of mobile phones and other consumer electronic devices. Referring to FIGS. 1-2D together, in one embodiment a user wishing to sell a used mobile phone, such as the mobile phone 250, approaches the kiosk 100 and identifies the type of device the user wishes to sell in response to prompts on the display screen 104. Next, the user may be prompted to remove any cases, stickers, or other accessories from the device so that it can be accurately evaluated. Additionally, the kiosk 100 may print and dispense a unique identification label (e.g., a small adhesive-backed sticker with a quick response code (“QR code”), barcode, or other machine-readable indicia, etc.) from the label outlet 110 for the user to adhere to the back of the mobile phone 250. After this is done, the door 106 retracts and opens allowing the user to place the mobile phone 250 onto the transparent plate 244 in the inspection area 108 (FIG. 2A). The door 106 then closes and the transparent plate 244 moves the mobile phone 250 under the upper chamber 230 as shown in FIG. 2B. The upper chamber 232 then moves downwardly to generally enclose the mobile phone 250 between the upper and lower chambers 230 and 232, and the cameras and/or other imaging components in the upper and lower chambers 230 and 232 perform a visual inspection of the mobile phone 250. In some embodiments, the visual inspection can include a computer-implemented visual analysis (e.g., a three-dimensional (“3D”) analysis) performed by a processing device within the kiosk (e.g., a CPU) to confirm the identification of the mobile phone 250 (e.g. make, model and/or sub-model) and/or to evaluate or assess the condition and/or function of the mobile phone 250 and/or its various components and systems. For example, the visual analysis can include computer-implemented evaluation (e.g., a digital comparison) of images of the mobile phone 250 taken from top, side and/or end view perspectives to determine length, width, and/or height (thickness) dimensions of the mobile phone 250. The visual analysis can further include a computer-implemented inspection of a display screen on the mobile phone 250 to check for, e.g., cracks in the glass and/or other damage or defects in the LCD (e.g., defective pixels, etc.). In some embodiments, the kiosk 100 can perform the visual analysis using one or more of the methods and/or systems described in detail in the commonly owned patents and patent applications identified herein and incorporated by reference in their entireties.

Referring next to FIG. 2C, after the visual analysis is performed and the device has been identified, the upper chamber 230 returns to its upper position and the transparent plate 244 returns the mobile phone 250 to its initial position near the door 106. The display screen 104 can also provide an estimated price, or an estimated range of prices, that the kiosk 100 may offer the user for the mobile phone 250 based on the visual analysis, and/or based on user input (e.g., input regarding the type, condition, etc. of the phone 250). If the user indicates (via, e.g., input via the touch screen) that they wish to proceed with the transaction, the connector carrier 240 automatically rotates an appropriate one of the connectors 242 into position adjacent the transparent plate 244, and door 106 is again opened. The user can then be instructed (via, e.g., the display screen 104) to withdraw the selected connector 242 (and its associated wire) from the carrousel 240, plug the connector 242 into the corresponding port (e.g., a USB port) on the mobile phone 250, and reposition the mobile phone 250 in the inspection area on the transparent plate 244. After doing so, the door 106 once again closes and the kiosk 100 (e.g. the kiosk CPU) performs an electrical inspection of the device via the connector 242 to further evaluate the condition of the phone as well as specific component and operating parameters such as the memory, carrier, etc. In addition or alternatively, in some embodiments the electrical inspection can include a determination of phone manufacturer information (e.g., a vendor identification number or VID) and product information (e.g., a product identification number or PID). In some embodiments, the kiosk 100 can perform the electrical analysis using one or more of the methods and/or systems described in detail in the commonly owned patents and patent applications identified herein and incorporated by reference in their entireties.

After the visual and electronic analysis of the mobile phone 250, the user is presented with a phone purchase price via the display screen 104. If the user declines the price (via, e.g., the touch screen), a retraction mechanism (not shown) automatically disconnects the connector 242 from the mobile phone 250, the door 106 opens, and the user can reach in and retrieve the mobile phone 250. If the user accepts the price, the door 106 remains closed and the user may be prompted to place his or her identification (e.g., a driver's license) in the ID scanner 112 and provide a thumbprint via the fingerprint reader 114. As a fraud prevention measure, the kiosk 100 can be configured to transmit an image of the driver's license to a remote computer screen, and an operator at the remote computer can visually compare the picture (and/or other information) on the driver's license to an image of the person standing in front of the kiosk 100 as viewed by one or more of the cameras 116a-c (FIG. 1) to confirm that the person attempting to sell the phone 250 is in fact the person identified by the driver's license. In some embodiments, one or more of the cameras 116a-c can be movable to facilitate viewing of kiosk users, as well as other individuals in the proximity of the kiosk 100. Additionally, the person's fingerprint can be checked against records of known fraud perpetrators. If either of these checks indicates that the person selling the phone presents a fraud risk, the transaction can be declined and the mobile phone 250 returned. After the user's identity has been verified, the transparent plate 244 moves back toward the upper and lower chambers 230 and 232. As shown in FIG. 2D, however, when the upper chamber 230 is in the lower position the gate 238 permits the transparent plate 244 to slide underneath but not electronic devices carried thereon. As a result, the gate 238 knocks the mobile phone 150 off of the transparent plate 244, onto the binning plate 236 and into the bin 234. The kiosk can then provide payment of the purchase price to the user. In some embodiments, payment can be made in the form of cash dispensed from the cash outlet 118. In other embodiments, the user can receive remuneration for the mobile phone 150 in various other useful ways. For example, the user can be paid via a redeemable cash voucher, a coupon, an e-certificate, a prepaid card, a wired or wireless monetary deposit to an electronic account (e.g., a bank account, credit account, loyalty account, online commerce account, mobile wallet etc.), Bitcoin, etc.

As those of ordinary skill in the art will appreciate, the foregoing routines are but some examples of ways in which the kiosk 100 can be used to recycle or otherwise process consumer electronic devices such as mobile phones. Although the foregoing example is described in the context of mobile phones, it should be understood that the kiosk 100 and various embodiments thereof can also be used in a similar manner for recycling virtually any consumer electronic device, such as MP3 players, tablet computers, PDAs, and other portable devices, as well as other relatively non-portable electronic devices such as desktop computers, printers, devices for implementing games, entertainment or other digital media on CDs, DVDs, Blu-ray, etc. Moreover, although the foregoing example is described in the context of use by a consumer, the kiosk 100 in various embodiments thereof can similarly be used by others, such as a store clerk, to assist consumers in recycling, selling, exchanging, etc. their electronic devices.

The Figures described herein and below include representative flow diagrams and other information that depict processes used in some embodiments of the present technology. These flow diagrams may not show all functions or exchanges of data, but instead they provide an understanding of commands and data exchanged under the systems described herein. Those skilled in the relevant art will recognize that some functions or exchange of commands and data may be repeated, varied, omitted, or supplemented, and other (less important) aspects not shown may be readily implemented. Those skilled in the art will appreciate that the blocks shown in the flow diagrams discussed below may be altered in a variety of ways. For example, while processes or blocks are presented in a given order, alternative implementations may perform routines in a different order, and some processes or blocks may be rearranged, deleted, moved, added, subdivided, combined, and/or modified to provide alternative or sub-combinations. Each of these processes or blocks may be implemented in a variety of different ways. Also, although processes or blocks are at times shown as being performed in series, these processes or blocks may instead be performed or implemented in parallel, or may be performed at different times. The steps depicted in the flow diagrams and/or represented by other tables, formulas, etc. can themselves include a sequence of operations that need not be described herein. Those of ordinary skill in the art can create source code, microcode, program logic arrays and/or or computer-readable instructions to implement the depicted steps and routines based on the flowcharts and the detailed description provided herein. The routines and portions thereof can be stored in non-volatile memory that forms part of a processor contained in the kiosk 100 or otherwise associated with the kiosk 100 (e.g., a remote processor operably connected to the kiosk 100 via a wired/wireless communication link, etc.), or they can be stored in removable media, such as disks, or hardwired or preprogrammed in chips, such as EEPROM semiconductor chips.

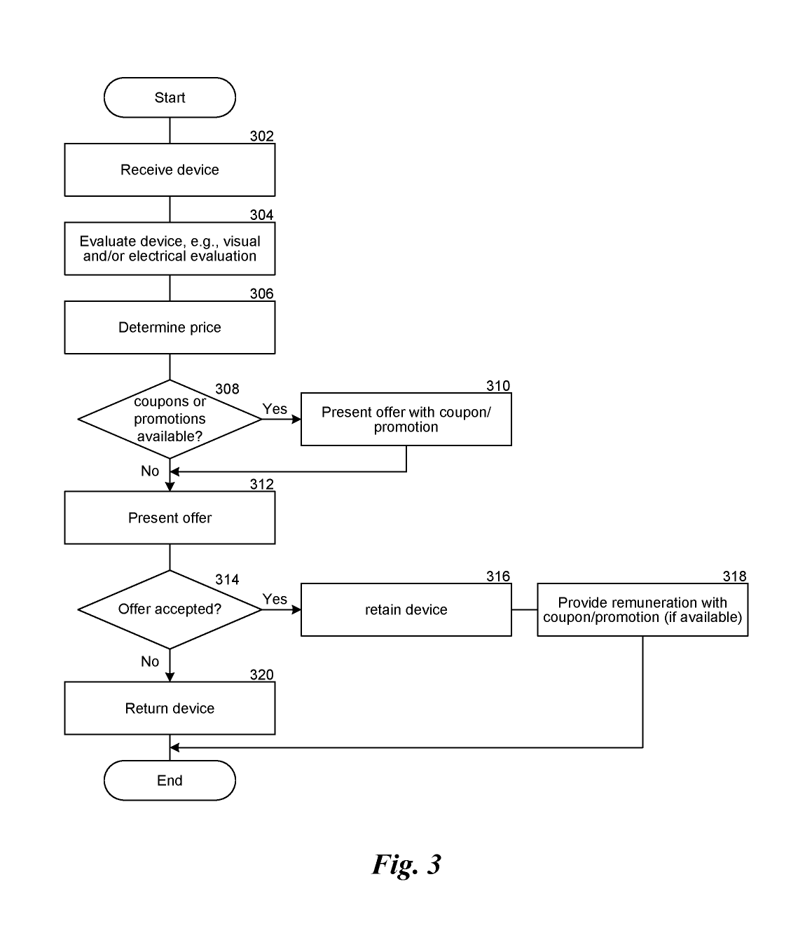

FIG. 3 is a flow diagram of a routine 300 that can be performed by the kiosk 100 for purchasing devices, e.g., mobile phones and/or other electronic devices, from users in accordance with an embodiment of the present technology. The routine can be executed by a processing device in accordance with computer-executable instructions stored on memory. In step or block 302, the routine receives the device from the user (e.g., in the inspection area 108 of the kiosk 100 (FIG. 1)). In block 304, the routine performs an evaluation, e.g., a visual and/or electrical inspection of the device, to determine various information about the device that can affect the device value. Such information can include, for example, the make, model, sub-model of the device, the device features (e.g., memory size, cell service carrier, etc.), device operability, device charge and/or rechargeability, physical condition, display function and condition, etc. After the device has been evaluated, the routine proceeds to block 306 to determine a price to offer the user for the device. In block 308, the routine determines whether there is currently a coupon/promotion being offered. The coupon/promotion may be for a specific electronic device or model. Alternatively, the coupon/promotion may be generic to any type of electronic device that is being redeemed. Such coupons/promotions may be unique to the retail store in which the kiosk is located. Alternatively, the coupon may be date specific without regard to the location of the kiosk (e.g. Black Friday after U.S. Thanksgiving etc.) If there is a coupon/promotion that is available, then the routine presents the offer to the user at 310 (via, e.g., a textual message on the display screen 104, an audio speaker, etc.) that includes the coupon/promotion information. If no coupon/promotion is currently available, then an offer is presented to the user at 312 that does not mention any coupon/promotion, In decision block 314, the routine determines if the user has accepted the offer price (by, e.g., providing input via a touch screen, key pad, microphone, etc. operably coupled to the kiosk 100). If the user declines the offer, the routine proceeds to block 320 and returns the device to the user. Conversely, if the user accepts the offer, the routine proceeds to block 316 and the routine retains the device (e.g., in the collection bin 234 of the kiosk 100). At block 318, the routine provides remuneration to the user in the amount of the purchase price. Such remuneration or payment can be in the form of, e.g., cash, a voucher redeemable for cash, electronic value (e.g., bitcoin, e-certificates, credit to electronic payment account, etc.), credit (e.g., a prepaid credit card, debit card, gift card, etc.) if no coupon/promotion is part of the offer. Alternatively, if the offer presented included a coupon/promotion, then the remuneration may include a printed or electronic voucher for merchandise, services, etc., coupons, loyalty points, and/or other forms of value. After block 320, the routine ends.

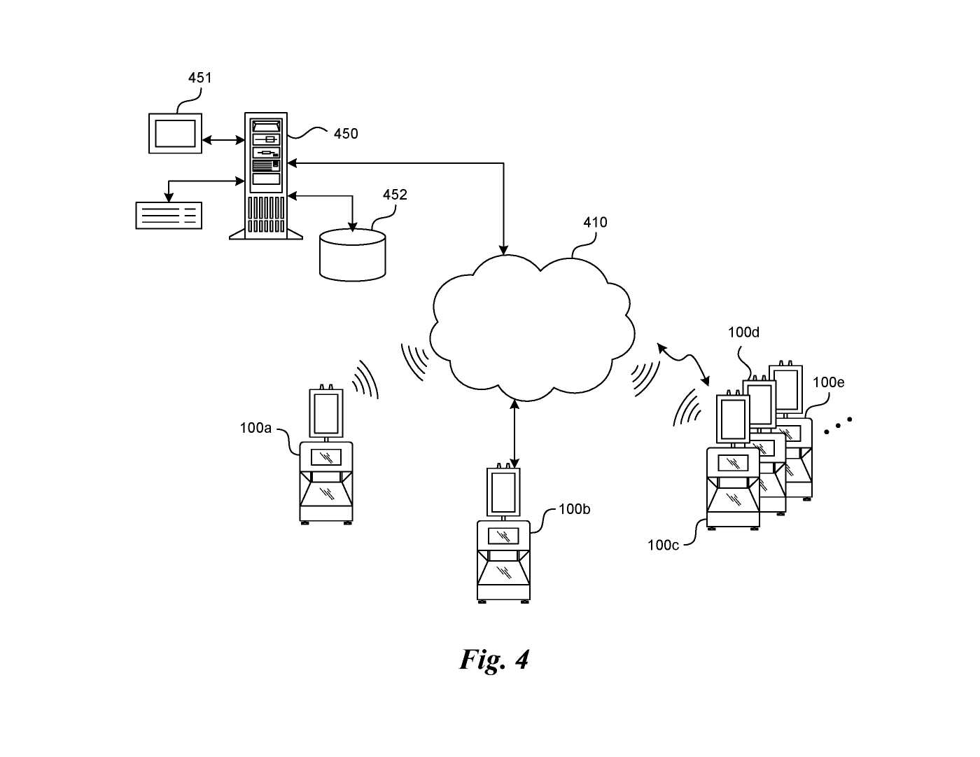

FIG. 4 illustrates a system for distributing coupons or other cross-promotional rebates to a number of remotely located electronic recycling kiosks. As discussed above, a number of kiosks 100a-100e are connected by a wired (e.g. cable, DSL, POTS telephone line, LAN etc.) or wireless (e.g. 802.11 Wifi, 802.16 WiMax, 3GPP, LTE, satellite etc.) to a server computer 450. The server 450 may be a single server for all the kiosks in the system or may comprise a number of servers that each service a specific region of kiosks (e.g. different countries, different states, different cities, different geographic regions etc.) In yet another embodiment, servers may be associated with specific businesses (e.g. Walmart®, Target® etc.)

The kiosk server(s) 450 include a database 452 that stores information about promotions, rebates, special offers, bonus dollars or the like that can be used by one or more of the kiosks. The coupons/promotions may include information and artwork that is specific to a particular business (e.g. its trademarks, logos etc.) or location (e.g. images of a particular region). Information stored for a coupon/promotion can include but is not limited to indications of fonts or colors to be used, the placement of words and images on a screen or printed version of the coupon/promotion, times at which the coupon/voucher is to be promoted, expiry date of the coupon/promotion etc. In one embodiment, the coupons/promotions are customized for demographics of the customers who frequent the business or live in the geographic region.

In the embodiment shown, the kiosk 100a is connected via a wireless link to a communication channel 410 such as the Internet. The kiosk 100a may be a single kiosk that is located in a single retail store. The kiosk 100b is connected to the communication channel 410 via a wired communication link. The kiosk 100b may be located for instance in a public place such as library, community center, school etc. The kiosks 100c-100d etc. may be located in a chain of stores and connected to a communication channel via a wired or wireless link.

In the embodiment shown, the server 450 is configured to transmit information regarding promotions, coupons, rebates, bonus dollars and the like to the kiosks associated with a particular store or location. For example, special coupons or promotions can be transmitted to all kiosks located in Walmart® stores, while information for different coupons or promotions can be transmitted to kiosks located in Target® stores. Because each kiosk is separately addressable from the server 450, variations in the terms or rules associated with each coupon or promotion can be made depending on the location or store affiliation of the kiosk. For example, kiosks in New Orleans may be programmed to offer special coupons/promotions during Mardi Gras, while kiosks in Chicago or Boston may be programmed to offer special coupons/promotions on St. Patrick's Day.

In one embodiment, the server 450 runs a software program that provides a web-based application that provides a user interface 451 to a Business Development and Marketing staff for the purpose of defining promotions, cross promotions and couponing programs. The user interface allows operators to select the applicable retail stores, geographic regions, marketing channels or any combination thereof in order to define parameters for the coupons/promotions that are unique to the applicable retail stores or other locations. Any number of unique promotional deals may be defined and active simultaneously, each with their own parameters.

Supported promotions and cross-promotions may include: dispensing additional cash dollars from a kiosk to a confirmed customer of the retail store in which the kiosk is located; dispensing a coupon which entitles the customer to a discount off certain products or services provided at the retail store; dispensing a coupon which entitles the customer to a dollar-value worth of purchasing power with the applicable retail store; and dispensing a voucher or gift card which requires the customer to exchange for cash within the retail store thereby providing the store additional opportunities to spend money in the store.

The details of the promotions including one or more rules, forms, data for web pages or other screens to be shown or items to be printed for a user at a particular kiosk are stored in the database 452. Upon selection of a particular coupon or promotion, the information associated with the selected coupon/promotion is transmitted to the kiosk(s). In one embodiment, the database 452 stores a relation between particular stores and coupons/promotions. In another embodiment, the database 452 stores information for generic coupons/promotions that can be sent to any kiosk.

Each kiosk includes a processor that is programmed to display ads for a particular coupon/promotion. For example, the processor can use a calendaring program with references to particular coupons/promotions that are to be displayed on a particular day or at a particular time. Information about the coupon/promotion is stored in a memory (preferably non-volatile flash, solid state or mechanical hard drive or the like) at the kiosk when it is received from the server computer 450. Any particular coupon/promotion may include data for a start and end date as well as times at which the promotion is to be run or prevented from running.

In one example, promotions for discounts on wine/liquor that are presented at kiosks in a grocery store may be preferably shown after work hours when customers are doing their dinner shopping. Alternatively, such coupons/promotions may be prevented from running on Sunday mornings or other times when they may seem in poor taste or are not redeemable under local laws.

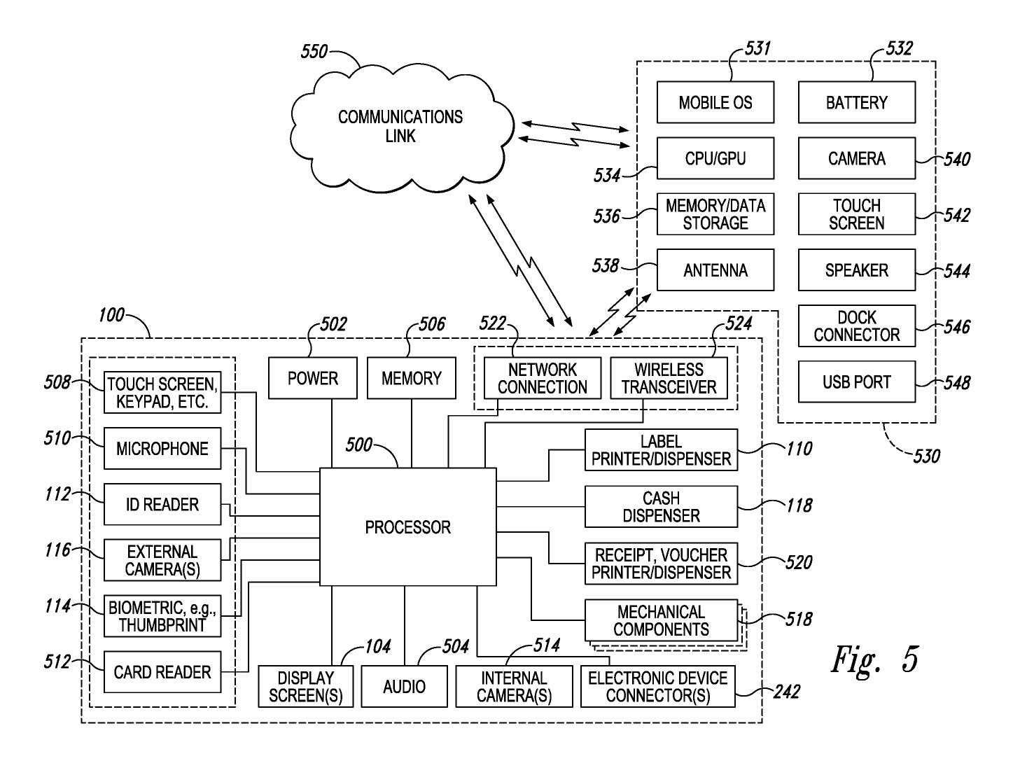

FIG. 5 provides a schematic representation of an architecture of the kiosk 100 in accordance with an embodiment of the present technology. In the illustrated embodiment, the kiosk 100 includes a suitable processor or central processing unit (“CPU”) 500 that controls operation of the kiosk 100 in accordance with computer-readable instructions stored on system memory 506. The CPU 500, for example, can control performance of the various pricing routines and/or generation of the weighted average prices described herein with reference to, for example, FIG. 3. The CPU 500 may be any logic processing unit, such as one or more CPUs, digital signal processors (DSPs), application-specific integrated circuits (ASICs), etc. The CPU 500 may be a single processing unit or multiple processing units in a device or distributed across multiple devices. The CPU 500 is connected to the memory 506 and may be coupled to other hardware devices, for example, with the use of a bus (e.g., a PCI Express or Serial ATA bus). The CPU 500 can include, by way of example, a standard personal computer (“PC”) (e.g., a DELL OPTIPLEX 780 or 7010 PC) or other type of embedded computer running any suitable operating system, such as Linux, Windows, Android, iOS, MAC OS, or an embedded real-time operating system. In some embodiments, the CPU 500 can be a small form factor PC with integrated hard disk drive (“HDD”) or solid-state drive (“SSD”) and universal serial bus (“USB”) or other ports to communicate with the other components of the kiosk 100. In other embodiments, the CPU 500 can include a microprocessor with a standalone motherboard that interfaces with a separate HDD. The memory 506 can include read-only memory (ROM) and random access memory (RAM) or other storage devices, such as disk drives or SSDs, that store the executable applications, test software, databases and other software required to, for example, implement the various routines described herein, control kiosk components, process electronic device information and data (to, e.g., evaluate device make, model, condition, pricing, etc.), communicate and exchange data and information with remote computers and other devices, etc.

The CPU 500 can provide information and instructions to kiosk users via the display screen 104 and/or an audio system (e.g., a speaker) 504. The CPU 500 can also receive user inputs via, e.g., a touch screen 508 associated with the display screen 104, a keypad with physical keys, and/or a microphone 510. Additionally, the CPU 500 can receive personal identification and/or biometric information associated with users via the ID reader 112, one or more of the external cameras 116, and/or the fingerprint reader 114. In some embodiments, the CPU 500 can also receive information (such as user identification and/or account information) via a card reader 512 (e.g., a debit, credit, or loyalty card reader having, e.g., a suitable magnetic stripe reader, optical reader, etc.). The CPU 500 can also control operation of the label dispenser 110 and systems for providing remuneration to users, such as the cash dispenser 118 and/or a receipt or voucher printer and an associated dispenser 520.

As noted above, the kiosk 100 additionally includes a number of electronic, optical and electromechanical devices for electrically, visually and/or physically analyzing electronic devices placed therein for recycling. Such systems can include one more internal cameras 514 for visually inspecting electronic devices to, e.g., determine the external dimensions and condition, and one or more of the electrical connectors 242 (e.g., USB connectors) for, e.g., powering up electronic devices and performing electronic analyses. As noted above, the cameras 514 can be operably coupled to the upper and lower chambers 230 and 232, and the connectors 242 can be movably and interchangeably carried by the carrousel 240 (FIGS. 2A-2D). The kiosk 100 further includes a plurality of mechanical components that are electronically actuated for carrying out the various functions of the kiosk 100 during operation. The mechanical components 518 can include, for example, the inspection area access door 106 and one or more of the movable components (e.g. the inspection plate 244, the upper and lower chambers 230 and 232, etc.) operably disposed within the inspection area 108 (FIG. 1). The kiosk 100 further includes power 502, which can include battery power and/or facility power for operation of the various electrical components associated with kiosk operation.

In the illustrated embodiment, the kiosk 100 further includes a network connection 522 (e.g., a wired connection, such as an Ethernet port, cable modem, FireWire cable, Lightning connector, USB port, etc.) suitable for communication with, e.g., all manner of remote processing devices via a communication link 550, and a wireless transceiver 524 (e.g., including a Wi-Fi access point, Bluetooth transceiver, near-field communication (NFC) device, and/or wireless modem or cellular radio utilizing GSM, CDMA, 3G and/or 4G technologies) for data communications suitable for communication with, e.g., all manner of remote processing devices via the communication link 550 and/or directly via, e.g., a wireless peer-to-peer connection. For example, the wireless transceiver 524 can facilitate wireless communication with handheld devices, such as a mobile device 530 (e.g., a smartphone) either in the proximity of the kiosk 100 or remote therefrom. By way of example only, in the illustrated embodiment the mobile device 530 can include one or more features, applications and/or other elements commonly found in smartphones and other known mobile devices. For example, the mobile device 530 can include a CPU and/or a graphics processing unit (“GPU”) 534 for executing computer readable instructions stored on memory 536. In addition, the mobile device 530 can include an internal power source or battery 532, a dock connector 546, a USB port 548, a camera 540, and/or well-known input devices, including, for example, a touch screen 542, a keypad, etc. In many embodiments, the mobile device 530 can also include a speaker 544 for two-way communication and audio playback. In addition to the foregoing features, the mobile device 530 can include a mobile operating system (OS) 531 and/or a device wireless transceiver that may include one or more antennas 538 for wirelessly communicating with, for example, other mobile devices, websites, and the kiosk 100. Such communication can be performed via, e.g., the communication link 550 (which can include the Internet, public and private intranet, a local or extended Wi-Fi network, cell towers, the plain old telephone system (POTS), etc.), direct wireless communication, etc.

Unless described otherwise, the construction and operation of the various components shown in FIG. 5 are of conventional design. As a result, such components need not be described in further detail herein, as they will be readily understood by those skilled in the relevant art. In other embodiments, the kiosk 100 and/or the mobile device 530 can include other features that may be different from those described above. In still further embodiments, the kiosk 100 and/or the mobile device 530 can include more or fewer features similar to those described above.

As described above, the processor 500 is configured to communicate with one or more remote server computers through a communication link 550 such as the internet through a network connection 522 or wireless transceiver 524. The processor 500 receives information about a particular coupon/promotion and stores it in memory 506. The memory 506 also stores the executable instructions for the operation of the kiosk as discussed above. The processor executes the instructions to determine which ads to display on a screen 104.

In one embodiment, the processor 500 looks in the memory 506 for any particular coupons or promotions once the kiosk has determined the type of electronic equipment that is being purchased from a user by its inspection system. The processor retrieves the rules for the particular promotion. The rules may specify the amount and type of rebate being offered and the dates the promotion is in effect. Other rules may also be provided. For example, a promotion that offers discounts or savings on alcohol should be limited to customers who can provide documentation showing they are age 21 and over. Therefore, the kiosk may request confirmation of the user's age prior to printing coupons on a printer 520 for such a rebate.

The kiosk 100 can receive updated information about coupons and promotions when the operators of the system use the server computer 450 to push such information to the kiosks. In another embodiment, the kiosk sends data that uniquely identifies it to the remote server. The data may be an alphanumeric code or serial no. that is associated with a particular location or store. In another embodiment, the kiosk includes a GPS receiver (not shown) that receives GPS signals in order to determine the location of the kiosk. The processor 500 is programmed to send the GPS coordinates of the kiosk 100 to the server 450, which uses the information to determine the identity of the kiosk and if there is any new coupon/promotion information to be sent to the kiosk.

In yet another embodiment of the disclosed technology, the wired or wireless communication link can be used to inform the server computer 450 that the kiosk is out of cash in the cash dispenser 118, that the kiosk needs additional ink in its printer, that it needs to be emptied of redeemed electronic items or is otherwise in need of service. This reduces unnecessary trips by service personnel to the kiosk.

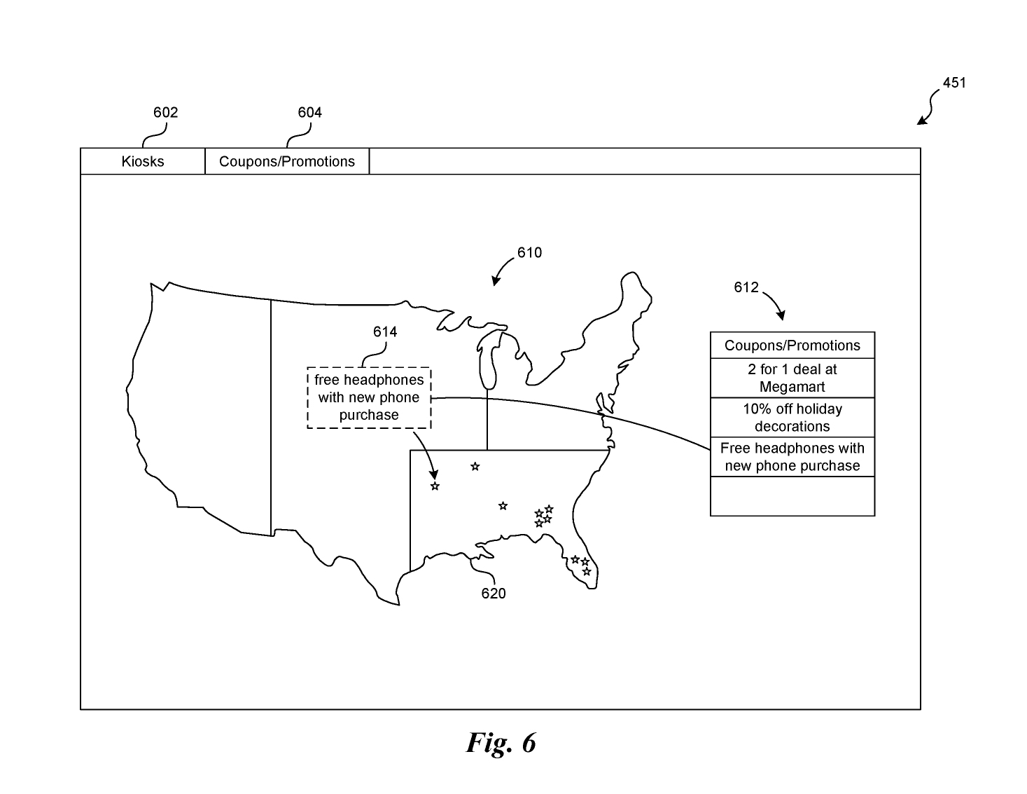

FIG. 6 shows an example of a representative user interface 451 that allows a user to select coupons/promotions for a particular kiosk. The user interface includes a control 602 that allows the user to select one or more kiosks to which new coupon/promotion information should be sent. The control can be used to select a particular geographic region having kiosks. For example, a map 610 of the United States can be divided into a number of regions (e.g. Northeast, Southeast, Middle America, and West Coast) that can be selected. The user can select all or a portion of the map by clicking on a region. In another embodiment, the control 602 allows the user to select kiosks by city and may include further controls to select kiosks within a defined distance of a landmark (e.g. up to 150 outside of Chicago etc.)

The database 452 at the server location stores the location of each kiosk. If a region, such as the Northeast United States is selected, the database is searched for all kiosks that are located in that geographic area. Alternatively, all the kiosks in the entire country can be selected or kiosks that are located in a particular city or in a particular neighborhood or with some other level of granularity can be selected. In another embodiment, the control 602 allows kiosks to be selected according to the particular store in which the kiosks are located. For example, all kiosks located in Kroger® or in QFC® grocery stores can be selected. In yet another embodiment, kiosks can be selected based on the likely demographics of customers where the kiosks are located. For example, kiosks can be selected where customers are more likely to drive pickup trucks and have dogs as pets. The map 610 may display the location of each selected kiosk.

The exemplary user interface also includes a control 604 that can be used to bring up a list 612 of coupons/promotions that can be sent to the kiosks. The list of coupons/promotions may be available to all of the kiosks. Alternatively, the list of coupons/promotions may be client specific. For example, some coupons/promotions may be used in kiosks that are located in Kroger® grocery stores but not QFC® grocery stores or vice versa.

In one embodiment, information for a particular coupon/promotion can be sent to the selected kiosks by dragging a description from the list onto the map. In one embodiment, the coupon/promotion information is sent to all the kiosks shown on the map. Alternatively, coupon/promotion information can be sent to fewer than all the kiosks shown—including sending coupon/promotion information to a single kiosk.

Upon detection that a user has selected a particular coupon/promotion to be transmitted to a particular set of kiosks, a processor of the server computer 450 sends the coupon/promotion information to the address of each selected kiosk.

As will be appreciated, the disclosed technology provides an operator with an easy way to push coupon/promotion information out to selected kiosks. In this way, all kiosks associated with a particular retailer can advertise the coupon/promotion at the same time without having to wait until the kiosks can be manually updated. In addition, the operator of the kiosks can start a coupon/promotion in one area of the country and easily roll the promotion out to other areas of the country. Similarly, coupon/promotions that are tailored to regional buying habits can be easily sent to kiosks in the corresponding geographic region.

The foregoing description of the electronic device recycling system illustrates but one possible network system suitable for implementing the various technologies described herein. Accordingly, those of ordinary skill in the art will appreciate that other systems consistent with the present technology can omit one or more of the facilities described.

Those of ordinary skill in the art will appreciate that the routines and other functions and methods described above can be performed by various processing devices, such as the kiosk processor 500 (FIG. 5), the server computer 450 (FIG. 4), or both. The processes can be implemented as an application specific integrated circuit (ASIC), by a digital signal processing (DSP) integrated circuit, through conventional programmed logic arrays or circuit elements. While many of the embodiments are shown and described as being implemented in hardware (e.g., one or more integrated circuits designed specifically for a task), such embodiments could equally be implemented in software and be performed by one or more processors. Such software can be stored on any suitable computer-readable medium, such as microcode stored in a semiconductor chip, on a computer-readable disk, or downloaded from a server and stored locally at a client.

The kiosks 100, mobile devices 330, server computers, user computers and/or other user devices, etc. may include one or more central processing units or other logic-processing circuitry, memory, input devices (e.g., keyboards and pointing devices), output devices (e.g., display devices and printers), and storage devices (e.g., magnetic, solid state, fixed and floppy disk drives, optical disk drives, etc.). Such computer devices may include other program modules such as an operating system, one or more application programs (e.g., word processing or spread sheet applications), and the like. The user computers may include wireless computers, such as mobile phones, personal digital assistants (PDAs), palm-top computers, etc., which communicate with the Internet via a wireless link. The computers may be general-purpose devices that can be programmed to run various types of applications, or they may be single-purpose devices optimized or limited to a particular function or class of functions. Aspects of the invention may be practiced in a variety of other computing environments.

While the Internet is shown, a private network, such as an intranet may likewise be used herein. The network may have a client-server architecture, in which a computer is dedicated to serving other client computers, or it may have other architectures such as peer-to-peer, in which one or more computers serve simultaneously as servers and clients. A database or databases, coupled to the server computer(s), stores much of the web pages and content exchanged between the user computers. The server computer(s), including the database(s), may employ security measures to inhibit malicious attacks on the system and preserve the integrity of the messages and data stored therein (e.g., firewall systems, message encryption and/or authentication (e.g., using transport layer security (TLS) or secure socket layers (SSL)), password protection schemes, encryption of stored data (e.g., using trusted computing hardware), and the like).

One skilled in the relevant art will appreciate that the concepts of the invention can be used in various environments other than location based or the Internet. In general, a display description may be in HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, may be used instead of the Internet. The system may be conducted within a single computer environment, rather than a client/server environment. Also, the user computers may comprise any combination of hardware or software that interacts with the server computer, such as television-based systems and various other consumer products through which commercial or noncommercial transactions can be conducted. The various aspects of the invention described herein can be implemented in or for any e-mail environment.

Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like, are generally used interchangeably herein, and refer to any of the above devices and systems, as well as any data processor. Input devices may include a touchpad, keyboard and/or a pointing device such as a mouse. Other input devices are possible such as a microphone, joystick, pen, game pad, scanner, digital camera, video camera, and the like. The data storage devices may include any type of computer-readable media that can store data accessible by a computer, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. The data storage devices may include any type of computer-readable media that can store data accessible by a computer, such as magnetic hard and floppy disk drives, optical disk drives, magnetic cassettes, tape drives, flash memory cards, DVDs, Bernoulli cartridges, RAM, ROMs, smart cards, etc. Indeed, any medium for storing or transmitting computer-readable instructions and data may be employed, including a connection port to a network such as a LAN, WAN, or the Internet. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). The terms “memory” and “computer-readable storage medium” include any combination of temporary, persistent, and/or permanent storage, e.g., ROM, writable memory such as RAM, writable non-volatile memory such as flash memory, hard drives, solid state drives, removable media, and so forth, but do not include a propagating signal per se.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like, are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples—alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. For example, the disclosed technology can be used to push additional information to a kiosk besides coupon/promotion information. Price information for a particular make/model of electronic equipment can be pushed to kiosks either as part of the coupon/promotion information or as separate information. In this way, a central server computer can easily change the prices offered for different types of electronic equipment in response to changing market conditions. A user may select kiosks in a particular geographic region, located in a particular store or individual kiosks that should receive the updated price information. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims. Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/we claim:

1. A system for providing coupon/promotion information to kiosks that purchase electronic equipment, comprising:
a database that stores information about coupons/promotions that are designated for kiosks associated with one of more of an identified business or location;
a processor that is programmed to
produce a user interface having a control with which a user can select one or more kiosks to receive coupon/promotion information;
identify information for one or more coupons/promotions to be transmitted to a selected kiosk; and
transmit the information associated with the identified coupon/promotion to one or more selected kiosks.

2. The system of claim 1, wherein the information for the coupons/promotions includes a start and an end time for the coupon/promotion.

3. The system of claim 1, wherein the information for the coupons/promotions includes an indication of a time at which the coupon/promotion should not be displayed.

4. The system of claim 1, wherein the processor is configured to receive data that identifies a kiosk; search the database for coupon/promotion information associated with the kiosk; and transmit information associated with the identified coupon/promotion information to the kiosk.

5. The system of claim 4, wherein the data is an alphanumeric identifier for the kiosk.

6. The system of claim 4, wherein the data is location information for the kiosk.

7. The system of claim 6, wherein the location information includes GPS data indicating the location of the kiosk.

8. The system of claim 1, wherein the database is configured to store a location for each kiosk and wherein the processor is configured to produce a user interface in which a user can select kiosks by location.

9. The system of claim 1, wherein the database is configured to store an indication of a retail store in which each kiosk is located and wherein the processor is configured to produce a user interface in which a user can select kiosks by retail store.

10. The system of claim 1, wherein the processor is configured to produce a user interface with one or more controls that allow a user to select one or more coupon/promotions that are to be transmitted to a kiosk.

11. A kiosk for purchasing electronic equipment that displays coupon/promotion information, comprising:
a computer readable memory that stores information about coupons/promotions that are to be used by the kiosk;
a processor that is programmed to control the display of selected coupons/promotion information that is read from the computer readable memory;
wherein the processor is configured to:
receive updated coupon/promotion information from a remote computer system via a wired or wireless communication link and to store the updated coupon/promotion information in the computer readable memory; and
display the coupon/promotion at the kiosk.

12. The kiosk of claim 11, wherein the processor is configured to transmit data identifying the kiosk to the remote computer system in order to determine if there is updated coupon/promotion information for the kiosk.

13. The kiosk of claim 11, wherein the processor is configured to transmit an alphanumeric identifier for the kiosk to the remote computer system to identify the kiosk.

14. The kiosk of claim 11, wherein the processor is configured to transmit location data for the kiosk in order to identify the kiosk.

15. The kiosk of claim 14, wherein the location data includes GPS coordinates of the kiosk.

16. A system for providing information to kiosks that purchase electronic equipment, comprising:
a database that stores information that is designated for kiosks associated with one of more of an identified business or location;
a processor that is programmed to
receive a request for updated information from one or more remotely located kiosks;
identify information to be transmitted to a requesting kiosk; and
transmit the information to the requesting kiosk.

17. The system of claim 16, wherein the information is for coupons/promotions to be offered by a kiosk for electronic equipment.

18. The system of claim 16, wherein the information is a price to be offered by a kiosk for a particular make and model of electronic equipment.
